(19) United States
(12) Patent Application Publication
(10) Pub. No.: US 2023/0231200 A1
(43) Pub. Date: Jul. 20, 2023

(54) MIXED ELECTROLYTE FOR LI-S BATTERY

(71) Applicant: THE REGENTS OF THE UNIVERSITY OF CALIFORNIA, Oakland, CA (US)

(72) Inventors: Gao LIU, Piedmont, CA (US); Thanh-Nhan TRAN, Berkeley, CA (US)

(21) Appl. No.: 18/064,187

(22) Filed: Dec. 9, 2022

Related U.S. Application Data
(60) Provisional application No. 63/361,385, filed on Dec. 15, 2021.

(51) Int. Cl. H01M 10/0569; H01M 10/0525; H01M 10/0567

(52) U.S. Cl. CPC H01M 10/0569; H01M 10/0525; H01M 10/0567; H01M 2300/0034; H01M 2300/0037

(57) ABSTRACT

The present invention provides for an electrolyte composition comprising an ether solvent, an amphiphilic molecule, an electrolyte solvent, and a lithium salt.

### CROSS REFERENCE TO RELATED APPLICATIONS

This application claims priority to U.S. Provisional Pat. Application Ser. No. 63/361,385, filed Dec. 15, 2021, which is incorporated by reference in its entirety.

### STATEMENT OF GOVERNMENTAL SUPPORT

The invention was made with government support under Contract No. DE-AC02-05CH11231 awarded by the U.S. Department of Energy. The government has certain rights in the invention.

### FIELD OF THE INVENTION

This invention relates generally to lithium rechargeable batteries, and more specifically to additives and electrolyte systems for lithium-sulfur rechargeable batteries.

### BACKGROUND OF THE INVENTION

Lithium ion batteries (LIBs) have been developed into an important technology for energy storage applications, while the demand for materials with high energy density is urgent. A strong demand for low-cost and high-energy-density rechargeable batteries has spurred lithium-sulfur (Li—S) rechargeable battery research. First, sulfur is an abundant and low-cost material. Second, the Gibbs energy of the lithium (Li) and sulfur reaction is approximately 2,600 Wh/kg, assuming the complete reaction of Li with sulfur to form Li2S, more than five times the theoretical energy of transition metal oxide cathode materials and graphite coupling. With these advantages, Li—S batteries could be both high energy density and low cost, satisfying demand in energy storage for transportation applications. The major obstacle is the loss of sulfur cathode material as a result of polysulfide dissolution into common electrolytes, which causes a shuttle effect and significant capacity fade. The polysulfide shuttle effect leads to poor sulfur utilization and fast-capacity fade, which have hindered widespread use of rechargeable Li—S batteries. Better electrolytes and additives for Li—S batteries are needed for reduction of polysulfide dissolution. The ideal electrolyte for sulfur electrode should have moderate ion conductivity, have more stability towards polysulfide, and promotes the polysulfide affiliation with the electrode substrate to prevent polysulfide dissolution.

### SUMMARY OF INVENTION

The present invention provides for an electrolyte composition comprising an ether solvent, an amphiphilic molecule, an electrolyte solvent, and a lithium salt.

In some embodiments, the ether solvent comprises an ether solvent molecule comprising an ether functional group, a carbonate functional group, or an ester functional group, or any mixture thereof. In some embodiments, the ether solvent molecule is linear or cyclic. In some embodiments, the ether solvent molecule comprises a plurality of ether functional groups, carbonate functional groups, or ester functional groups, or any mixture thereof. In some embodiments, the ether solvent molecule comprises 1, 2, 3, or 4 ether, carbonate or ester functional groups. In some embodiments, the ether solvent molecule comprises 1, 2, 3, 4, 5, 6, 7, 8, 9, 10, 11, 12, 13, 14, 15, 16, 17, 18, 19, or 20 carbon atoms. In some embodiments, the ether solvent molecule comprises 1, 2, 3, or 4 ring structures. In some embodiments, each ring structure comprises 1, 2, 3, 4, 5, 6, 7, 8, 9, or 10 carbon atoms. In some embodiments, the ether solvent molecule is a polymer.

In some embodiments, the ether solvent molecule is any one of the following molecules: dimethyl ether (CH³—O—CH³), ethyl methyl ether (CH³CH²—O—CH³), diethyl ether (CH³CH²—O—CH²CH³), dipropyl ether (CH³CH²CH²—O—CH²CH²CH³), diisopropyl ether ((CH³)²CH—O—CH(CH³)²), divinyl ether (CH²⁼CH—O—CH⁼CH²), 1,2-dimethoxyethane (DME) (CH³OCH²CH²OCH³), methyl phenyl ether (anisole)

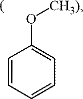

cyclopropyl methyl ether (

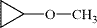

), diphenyl ether (

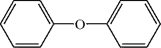 [SMILES: c1ccc(Oc2ccccc2)cc1]

), furan (

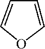

), tetrahydrofuran (THF) (

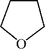

), 1,4-dioxane (

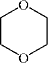

), or a mixture thereof.

In some embodiments, the ether solvent molecule is a cyclic ether having any one of the following structures:

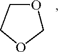

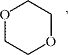

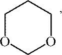

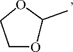

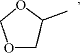

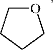

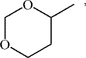

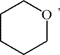

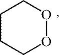

or a mixture thereof.

In some embodiments, the ether solvent is an ether synthesized using one or more of the following alcohols:

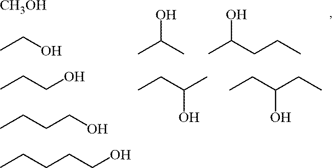

or a mixture thereof. The ether can be synthesized through an acid-catalyzed dehydration, or a Williamson ether synthesis, of the one or more alcohols.

In some embodiments, the ether solvent molecule is a cyclic carbonate having any one of the following structures:

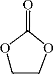

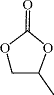

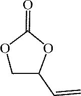

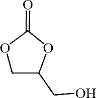

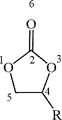

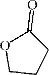

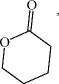

or a mixture thereof.

In some embodiments, the ether solvent molecule is a cyclic ester having any one of the following structures:

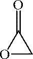

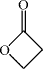

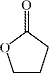

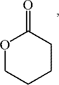

or a mixture thereof.

In some embodiments, the ether solvent molecule is dioxolane (DOL).

In some embodiments, the amphiphilic molecule has the following structure:

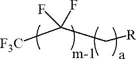

wherein R is

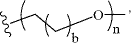

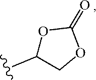

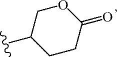

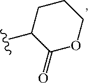

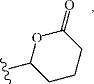

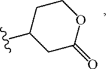

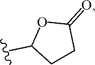

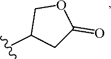

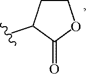

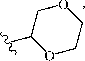

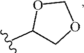

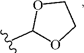

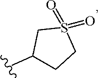

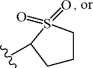

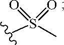

m is an integer from 1 to 21; a is an integer from 0 to 20; b is an integer from 0 to 4; and n is an integer from 1 to 20. In some embodiments, m is 1, 2, 3, 4, 5, 6, 7, 8, 9, 10, 11, 12, 13, 14, 15, 16, 17, 18, 19, 20, or 21. In some embodiments, a is 1, 2, 3, 4, 5, 6, 7, 8, 9, 10, 11, 12, 13, 14, 15, 16, 17, 18, 19, or 20. In some embodiments, b is 0, 1, 2, 3, or 4. In some embodiments, n is 1, 2, 3, 4, 5, 6, 7, 8, 9, 10, 11, 12, 13, 14, 15, 16, 17, 18, 19, or 20.

In some embodiments, the amphiphilic molecule has the following structure:

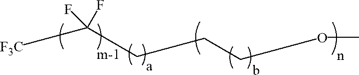

wherein m is an integer from 1 to 21, a is an integer from 0 to 20, b is an integer from 0 to 4, and n is an integer from 1 to 20.

In some embodiments, R is

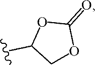

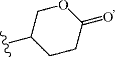

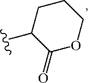

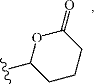

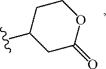

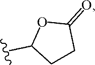

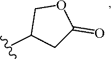

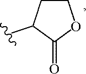

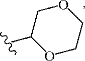

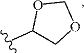

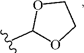

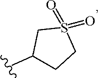

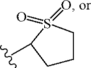

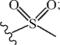

wherein m is an integer from 1 to 21; a is an integer from 0 to 20.

In some embodiments, the amphiphilic molecule has the following structure:

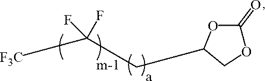

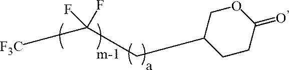

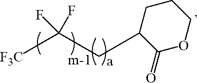

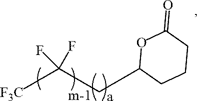

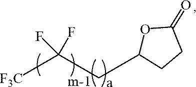

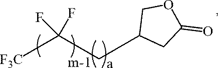

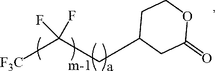

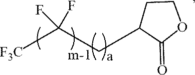

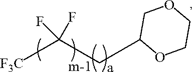

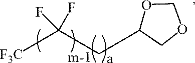

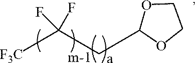

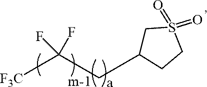

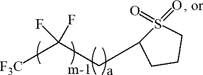

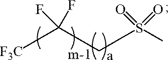

wherein m is an integer from 1 to 21; a is an integer from 0 to 20.

In a particular embodiment, the amphiphilic molecule has Chemical Structure II and is F₃EO₁, wherein m is 3, a is 0, b is 1 and n is 1. In a particular embodiment, the amphiphilic molecule has Chemical Structure II and is F₈EO₄wherein m is 8, a is 0, b is 1 and n is 4.

In some embodiments, the amphiphilic molecule is capable of self-formation of a micelle. In some embodiments, the micelle is an inverse micelle, prolate micelle, inverse prolate micelle, normal hexagonal phase, inverse hexagonal phase inverse, oblate micelle bilayered fragment, or the like. One skilled in the art can readily identify the polar and non-polar ends (or parts) of each amphiphilic molecule. The fluorinated alkyl is the polar end (or part), while the polyether and R group form the non-polar end (or part).

In some embodiments, the electrolyte solvent is a highly fluorinated alkane, alkyl ether or alkyl tertiary amine comprising more F atoms than H atoms. In some embodiments, the alkane has a main chain having 2, 3, 4, 5, 6, 7, 8, 9, 10, 11, 12, 13, 14, 15, 16, 17, 18, 19, or 20 carbon atoms. In some embodiments, the alkane has a straight or branched chain. In some embodiments, the alkane has a total of 3, 4, 5, 6, 7, 8, 9, 10, 11, 12, 13, 14, 15, 16, 17, 18, 19, or 20 carbon atoms. In some embodiments, the electrolyte solvent has the following chemical structure: R₁— O—R₂, or a quaternary ammonium salt (such as formed from the following reaction:

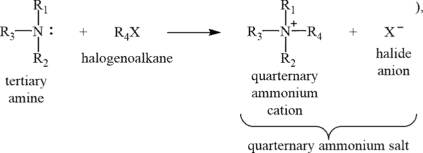

wherein R₁is —CH3, —C₂H₅, or —R₄; and R₂, R₃, and R₄ are each independently ―α―C_{y}H_{z}X_{2y}+_{1-z}, wherein α is -, —CHX—, —CX₂—, or —CH₂—; y is 1, 2, 3, 4, 5, 6, 7, 8, 9, or 10; and z is 0 or 1. In some embodiments, -C_{y}X_{y+2} is a straight chain alkyl. In some embodiments, -C_{y}X_{2y+1} is a branched alkyl, and y is equal to or more than 3. In some embodiments, R₁ and R₂ are identical. In some embodiments, R₂ and R₃ are identical. In some embodiments, R₁, R₂, and R₃ are identical. In some embodiments, X is F, Br, Cl, or I. In some embodiments, R₂, R₃, and R₄ are each independently ―α―C_{y}H_{z}F_{2y}+_{1-z}, wherein α is -, —CHF—, —CF₂—, or —CH₂—; y is 1, 2, 3, 4, 5, 6, 7, 8, 9, or 10; and z is 0 or 1. In some embodiments, —C_{y}F_{y}+₂ is a straight chain alkyl. In some embodiments, -C_{y}F_{2y}+₁ is a branched alkyl, and y is equal to or more than 3.

In some embodiments, the electrolyte solvent is methoxyperfluorobutane, perfluorinated alkane, bis(2,2,2-trifluoroethyl)ether, 1,1,2,2-tetrafluoroethyl-2′,2′,2′-trifluoroethyl ether, perfluorotributylamine, hydrofluoroether (HFE), or a mixture thereof. In some embodiments, the profluorinated alkane is C(H or F)₃[C(H or F)₂]ₓC(H or F)₃, wherein x is an integer from 0 to 20, and there are more F atoms than H atoms. In some embodiments, the profluorinated alkane is CF₃(CF₂)_{X}CF₃, wherein x is an integer from 0 to 20. In some embodiments, x is 1, 2, 3, 4, 5, 6, 7, 8, 9, 10, 11, 12, 13, 14, 15, 16, 17, 18, 19, or 20. In some embodiments, the hydrofluoroether (HFE) is CHF₂CF₂—O—CH₂CF₂CHF₂, C₇F₁₅—O—C₂H₅, C₄F₉—O—C₂H₅, n—C₃F₇—O—CH₃), CF₃CF₂—O—CH₃, CF₃CHFCF₂—O—CH₃, CF₃—O—CH₃, CHF₂—O—CHF₂, CF₃CF₂—O—CH₃), or CF₃—O—CHFCF₃. In some embodiments, the HFE is CHF₂CF₂—O—CH₂CF₂CHF₂. Chemical structure of different electrolyte solvents are shown in FIG. 1.

In some embodiments, the lithium salt is lithium bis(trifluoromethanesulfonyl)imide (LiTFSI), lithium bis(oxalato)borate (LiBOB), lithium bis(pentafluoroethanesulfonyl)imide (LiBETI), LiClO₄, lithium bis(fluorosulfonyl)imide (LiFSI), LiPF₆, LiAsF₆, or a mixture thereof. In some embodiments, the lithium salt has an ionic association strength that is equal to or less than about the ionic association strength of LiBETI, and is equal to or more than about the ionic association strength of LiTFSI.

In some embodiments, the electrolyte composition comprises one or more amphiphilic molecule of the present invention, or a mixture thereof; methoxyperfluorobutane, perfluorinated alkane, bis(2,2,2-trifluoroethyl)ether, 1,1,2,2-tetrafluoroethyl-2′,2′,2′-trifluoroethyl ether, perfluorotributylamine, or a mixture thereof; and, LiTFSI, LiBOB, LiBETI, LiClO₄, LiFSI, LiPF₆, LiAsF₆, or a mixture thereof.

In some embodiments, the electrolyte composition comprises F₃EO₁,:HFE=1:5 (v/v) and 0.5 M LiTFSI, wherein HFE is CHF₂CF₂—O—CH₂CF₂CHF₂. F₃EO₁, has the following chemical structure:

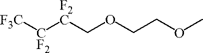 [SMILES: COCCOCC(F)(F)C(F)(F)C(F)(F)F]

In some embodiments, the electrolyte composition comprises F₈EO₄,:HFE=2:3 (v/v) and 0.5 M LiTFSI, wherein HFE is CHF₂CF₂—O—CH₂CF₂CHF₂. FIG. 2 shows the synthesis of F₈EO₄. FIG. 3 shows the NMR for F₈EO₄. F₈EO₄ has the following chemical structure:

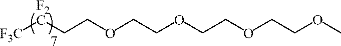

The shorthand labeling of biphiphilic additives FₙEOₘ is: “F” stands for the unit of —CF₂—and ending CF₃— moieties, and “n” is the number of the moieties; “EO” stands for the —CH₂CH₂O— ethyleneoxide moiety, the —CH2 end is covalently bond with CF₂—, and the O— end is covalently bond with a methyl moiety, “m” is the number of the —CH₂CH₂O— repeating units. The “F” segment is perfluorinated alkyl, and the “EO” segment is methyloligoethyleneoxide, wherein the two segments are linked by a covalent bond.

The present invention also provides for a lithium ion battery comprising the electrolyte composition of the invention.

The electrolyte composition of the present invention has more stability towards polysulfide, and promotes polysulfide affiliation with the electrode substrate to prevent polysulfide dissolution.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows chemical structures of suitable electrolyte solvent.

FIG. 2 shows the inhibition of the shuttle of lithium polysulfide, and the synthesis of F₈EO₄.

FIG. 3 shows the proton NMR of the major starting material and product.

FIG. 4 shows the cell test results for F₈EO₄:HFE=2:3 (v/v) 0.5 M LiTFSI, wherein HFE is CHF₂CF₂—O—CH₂CF₂CHF₂.

FIG. 5 shows the cell test results for F₈EO₄:HFE=2:3 (v/v) 0.5 M LiTFSI, wherein HFE is CHF₂CF₂—O—CH₂CF₂CHF₂.

FIG. 6 shows the cell test results for F₈EO₄:HFE=2:3 (v/v) 0.5 M LiTFSI, wherein HFE is CHF₂CF₂—O—CH₂CF₂CHF₂.

FIG. 7 shows the cell test results for F₈EO₄:HFE=1:5 (v/v) 0.5 M LiTFSI, wherein HFE is CHF₂CF₂—O—CH₂CF₂CHF₂.

FIG. 8 shows the cell test results for F₈EO₄:HFE=1:5 (v/v) 0.5 M LiTFSI, wherein HFE is CHF₂CF₂—O—CH₂CF₂CHF₂.

FIG. 9 shows the cell test results for F₈EO₄:HFE=9 (v/v) 0.5 M LiTFSI, wherein HFE is CHF₂CF₂—O—CH₂CF₂CHF₂.

FIG. 10 shows the cell test results for F₈EO₄:HFE=9 (v/v) 0.5 M LiTFSI, wherein HFE is CHF₂CF₂—O—CH₂CF₂CHF₂.

FIG. 11 shows the baseline of DOL:dimethyl ether (DME)=1:1, 1 M LiTFSI cell test results, wherein HFE is CHF₂CF₂—O—CH₂CF₂CHF₂.

FIG. 12 shows the baseline of DOL:DME=1:1, 1 M LiTFSI cell test results, wherein HFE is CHF₂CF₂—O—CH₂CF₂CHF₂.

FIG. 13 shows the synthesis of the FₙEOₘ amphiphilic additives..

FIG. 14 shows the proton NMR of the major starting material and product.

FIG. 15 shows the cell test results for F₃EO1:HFE=1:5 (v/v) 0.5 M LiTFSI, wherein HFE is CHF₂CF₂—O—CH₂CF₂CHF₂.

FIG. 16 shows the cell test results for F₃EO₁:HFE=1:5 and 1:1 (v/v) 0.5 M LiTFSI, wherein HFE is CHF₂CF₂—O—CH₂CF₂CHF₂.

FIG. 17 shows the cell test results for F₃EO₁:HFE=1:5 (v/v) 0.5 M LiTFSI, wherein HFE is CHF₂CF₂—O—CH₂CF₂CHF₂.

FIG. 18 shows the lithium metal electrode under the F₃EO₁:HFE=1:5 (v/v) 0.5 M LiFSI electrolyte, wherein HFE is CHF₂CF₂—O—CH₂CF₂CHF₂. The cell is Li metal against Cu electrode. Operated at above defined current density of 0.5 mA/cm² for 2 hours for lithium deposition to Cu electrode, and then stripping of lithium metal from Cu electrode at the same current density unit the cell voltage reaches 1 V.

FIG. 19 shows the lithium metal electrode under the F₃EO₁:HFE=1:5 (v/v) 0.5 M LiFSI electrolyte, wherein HFE is CHF₂CF₂—O—CH₂CF₂CHF₂.

FIG. 20 shows the lithium metal electrode under the F₃EO₁:HFE=1:5 (v/v) 0.5 M LiFSI electrolyte, wherein HFE is CHF₂CF₂—O—CH₂CF₂CHF₂. The cell is Li metal against Cu electrode. Operated at above defined current density of 1mA/cm² for 1 hour for lithium deposition to Cu electrode, and then stripping of lithium metal from Cu electrode at the same current density unit the cell voltage reaches 1 V.

FIG. 21 shows the lithium metal electrode under the F₃EO₁:HFE=1:5 (v/v) 0.5 M LiFSI electrolyte, wherein HFE is CHF₂CF₂—O—CH₂CF₂CHF₂.

FIG. 22 shows the lithium metal electrode under the F₃EO₁:HFE=1:5 (v/v) 0.5 M LiFSI electrolyte, wherein HFE is CHF₂CF₂—O—CH₂CF₂CHF₂. The cell is Li metal against Cu electrode. Operated at above defined current density of 2mA/cm² for 0.5 hours for lithium deposition to Cu electrode, and then stripping of lithium metal from Cu electrode at the same current density unit the cell voltage reaches 1 V.

FIG. 23 shows the lithium metal electrode under the F₃EO₁:HFE=1:5 (v/v) 0.5 M LiFSI electrolyte, wherein HFE is CHF₂CF₂—O—CH₂CF₂CHF₂.

FIG. 24 shows the first cycle lithium metal deposition using the F₃EO₁:HFE=1:5 (v/v) 0.5 M LiFSI electrolyte, wherein HFE is CHF₂CF₂—O—CH₂CF₂CHF₂.

FIG. 25 shows the first cycle lithium metal deposition using the DOL:DME=1:1 (v/v) 1 M LiTFSI electrolyte and 1% LiNO₃.

FIG. 26 shows the capacity vs. voltage for a high voltage lithium metal cell.

FIG. 27 shows capacity stability during high voltage lithium metal cell cycling.

FIG. 28. Li—S battery recycling with different amounts of DOL added. A. The capacity and coulombic efficiency vs. cycle numbers of the Li—S cell with the DOL additives at 5, 10, 15% by weight. B. The voltage and capacity profile of the Li—S cell at the 25^{th} cycle (Panel B) with the DOL additive at 5, 10, 15% by weight. C. The capacity and coulombic efficiency vs. cycle numbers of the Li—S cell with the DOL additives at 5, 10, 15% by weight, and saturated with LiTFSI salt. D. The voltage and capacity profile of the Li—S cell at the 15^{th} cycle (of Panel C) with the DOL additive at 5, 10, 15% by weight, and saturated with LiTFSI salt.

FIG. 29. 0.5 M LiTFSI in F₄EO₂/TTE (v/v,1:5) electrolyte: (a) i-t curve of DC polarization process. (b) Impedance of the cell before and after polarization. (c) The transference number of LiTFSI in F₄EO₂/TTE electrolyte as a function of concentration with error bars from multiple tests.

FIG. 30. The S concentration detected from the supernatant of the electrolyte solution saturated by Li2S, S, and all types of polysulfides (Li₂Sₘ, m = 2, 4, 6, 8) respectively. The error bar was calculated based on Gaussian distribution analysis. In comparison, the S concentration of 1.0 M LiTFSI in DOL is 6.3 M based on the literature.

FIG. 31. (A) Cycling performance of lithium-sulfur cells with different LiTFSI concentrations with 0.6 M LiNO₃ in DOL/DME (1/1, v/v) and (B) Coulombic efficiency evolution during the cycling test.

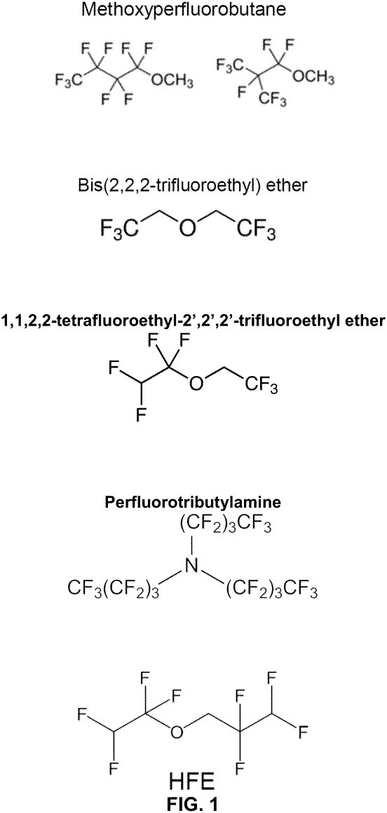

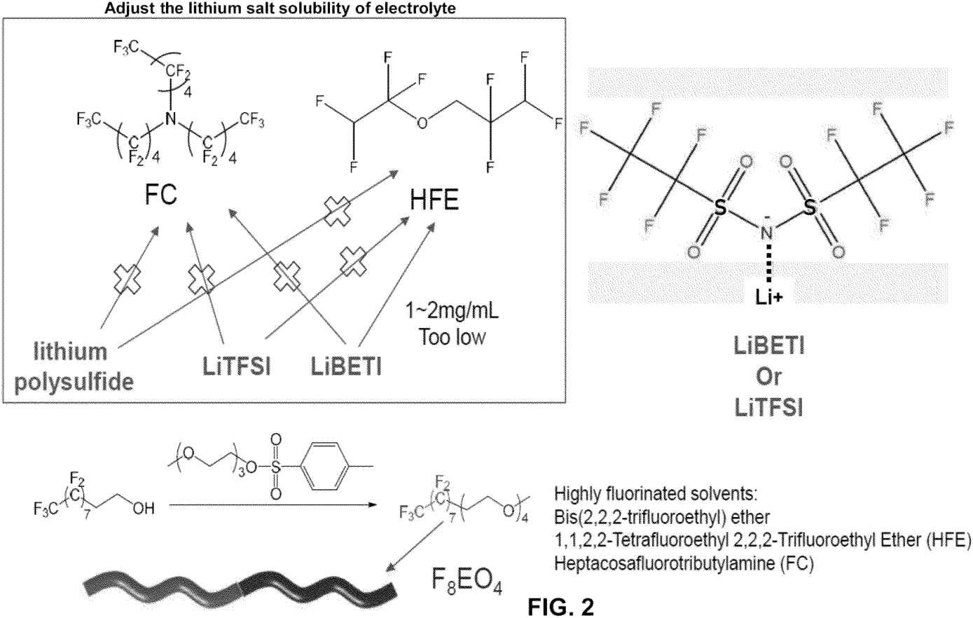

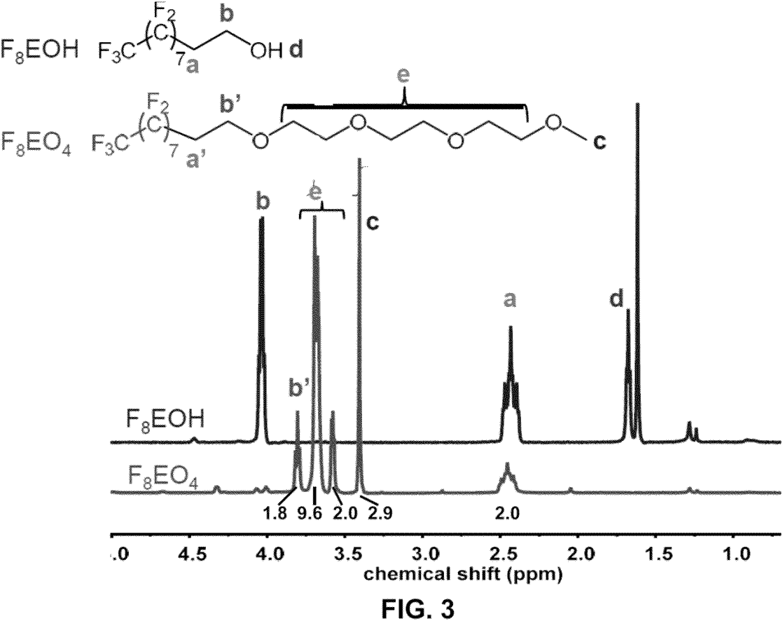

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

As used in the specification and the appended claims, the singular forms “a,” “an,” and “the” include plural referents unless the context clearly dictates otherwise. Thus, for example, reference to “molecules” includes a plurality of a molecule species as well as a plurality of molecules of different species.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The term “about” refers to a value including 10% more than the stated value and 10% less than the stated value.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

The amphiphilic molecule and electrolyte composition of the present invention can be used for rechargeable Li—S battery, and can promote lithium salt (such as, LITFSI) dissolution into electrolyte, but preventing polysulfide dissolution during cell operation. In a particular embodiment, the new electrolyte comprises of a highly fluorinated solvent (such as, 1,1,2,2-Tetrafluoroethyl 2,2,2-Trifluoroethyl Ether), a lithium salt (such as, LiTFSI), and a “biphiphilic” additive F₈EO₄.

The additive molecules can form micelles in the highly fluorinated solvent. The micelle core is methyloligoethyleneoxide, and the perfluorinated alkyls extend to the highly fluorinated solvent. The highly fluorinated solvent does not dissolve polysulfide. The combination solvent can effectively dissolve LiTFSI to 0.5 M concentration in the micelle core for any of the amphiphilic molecule, including but not limited to F₈EO₄ and F₃EO₁. The main solvent body is any highly fluorinated solvent, which prevents polysulfide dissolution.

All the current electrolytes and additives for electrolyte are distributed homogeneously. This invention uses a bi-functional additive to form micelle structures within the electrolyte. The micelle core selectively dissolves lithium salt, and the bulk of electrolyte solvent of highly fluorinated solvent prevents polysulfide dissolution.

Amphiphilic molecules of the present invention can be synthesized using the following method (with this particular example provided for the synthesis of F₈EO₄)—

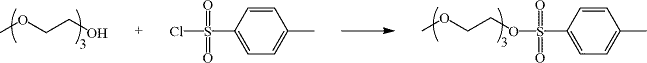

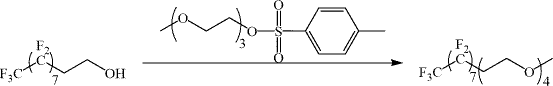

FIG. 13 shows the synthesis of F₃EO₁. One skilled in the art can readily be able to synthesize any FₙEOₘ by selecting different reactants for Reactions 1 and 2 in order to synthesize the desired FₙEOₘ.

The EO₃-Tosylate (shown in Reaction 1 above) is synthesized according to J. Org. Chem. 2018, 83, 1903-1912. The synthetic procedure of FEO is stated as follows: 5.088 g EO3-Tosylate (16 mmol) and 3.72 g F—OH (8 mmol) are added to 4.8 mL NMP and followed by adding 4.8 mL 48 wt% KOH solution. The mixture is heated at 50° C. for 5 hours and 70° C. for another 2 h. After cooling down, 50 mL of ether is added and extracted against water to remove the impurities. The FEO (3.5 g, yield: 76%) was finally obtained after evaporating the solvent under vacuum.

In some embodiments, the present invention can be used in a high voltage lithium ion and lithium metal battery. In some embodiments, the cathode comprises NMC622 materials (LiNi_{0.6}Mn_{0.2}Co_{0.2}O). In some embodiments, the anode comprises lithium metal. In some embodiments, the electrolyte comprises 0.5 M LiTFSI in F4/TTE (1:5) electrolyte. In some embodiments, the battery is a coin cell. In some embodiments, the battery has an operational voltage 2.75 V - 4.4 V.

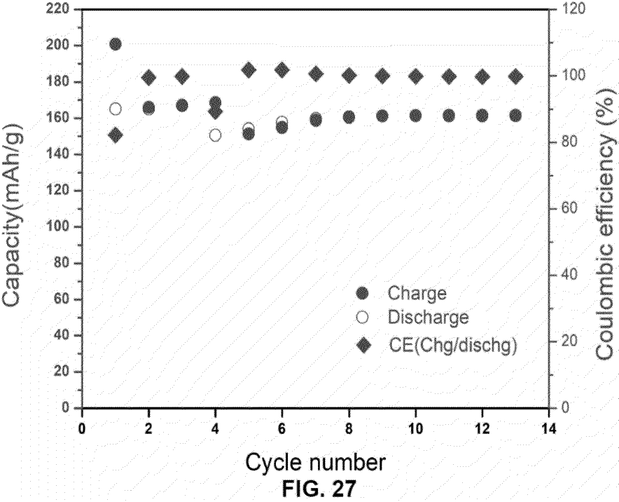

A high voltage lithium ion and lithium metal battery is fabricated comprising the following: the cathode comprises NMC622 materials (LiNi_{0.}₆Mn_{0.2}Co_{0.2}O), the anode comprises lithium metal, the electrolyte comprising 0.5 M LiTFSI in F4/TTE (1:5) electrolyte. The battery is tested as follows: C/10 first 2 cycles, and C/3 cycling subsequent cycling. FIG. 26 shows the capacity vs. voltage for the high voltage lithium metal cell. FIG. 27 shows capacity stability during the high voltage lithium metal cell cycling.

The electrolytes can be used for high voltage lithium metal cells. In some embodiments, the cathode is an NMC material (such as (111, 532, 622 or 811)), NCA materials (such as LiNi_{0.8}Co₀.₁₅Al_{0.05}O₂), or Nickelate material (such as LiNiO₂). In some embodiments, the cell voltage can range from 2.5 V to 6 V. In some embodiments, the anode is a Cu, Ni, or Ti, Lithium metal; a Si based material (such as Si, Si/C, SiOx), carbon base materials (such as graphite), or a mixture thereof (such as a mixture of Si based materials and carbon based materials). In some embodiments, the electrolyte is any combination of the amphiphilic electrolyte and compositions disclosed herein.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

The invention having been described, the following examples are offered to illustrate the subject invention by way of illustration, not by way of limitation.

### Example 1

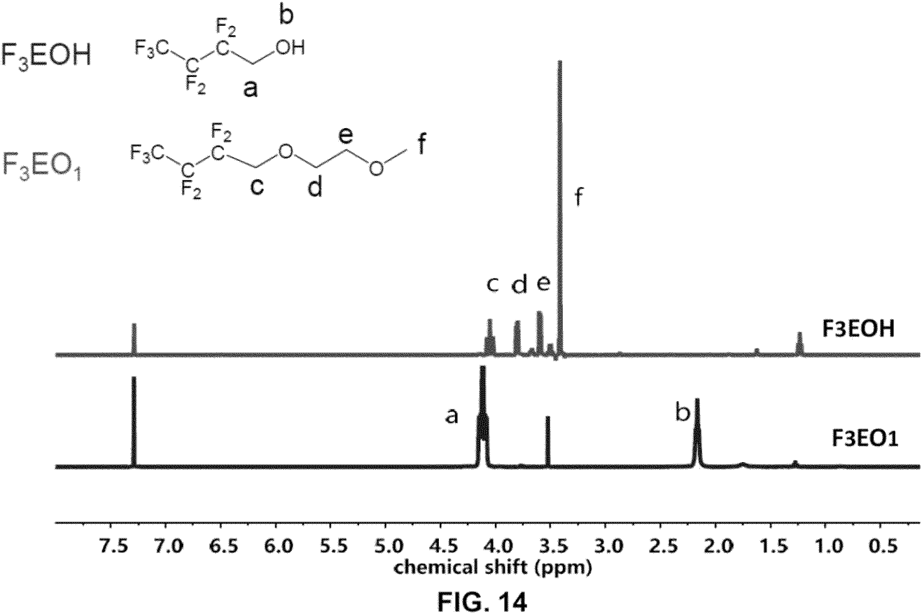

The Li—S cell performance results obtained are reported herein. F₈EO₄ and F₃EO₁ are separately synthesized using the method taught herein. FIG. 14 shows the NMR to demonstrate the successful synthesis of F₈EO₄ and F₃EO₁. LiTFSI is tested for solubility and conductivity in different ratios of HFE and either F₈EO₄ or F₃EO₁.

TABLE 1

LiTFSI solubility and conductivity test in the amphiphilic solvents

| Ratio Vol. | F₈EO₄ (mL) | HFE (mL) | LITFSI (M) | σ(mS/cm) |
|---|---|---|---|---|
| 1:1 | 0.75 | 0.75 | 0.5 | 0.61 |
| 1:1.5 | 0.5 | 0.5 | 0.5 | 0.7 |
| 1:2 | 0.6 | 0.9 | 0.5 | 0.72 |
| 1:5 | 0.1 | 0.5 | 0.5 | 0.35 |
| 1:9 | 0.1 | 0.9 | 0.3 | 0.12 |

LiTFSI does not dissolve in the 1:9 electrolyte with a concentration of 0.5 M.

TABLE 2

LiTFSI solubility and conductivity test in the amphiphilic solvents

| Ratio Vol. | FEO (mL) | HFE (mL) | LITFSI (M) | σ(mS/cm) |
|---|---|---|---|---|
| 1:1 | 0.75 | 0.75 | 0.5 | 3.2 |
| 1:5 | 0.1 | 0.5 | 0.5 | 1.05 |

“FEO” in Table 2 is F₃EO₁.

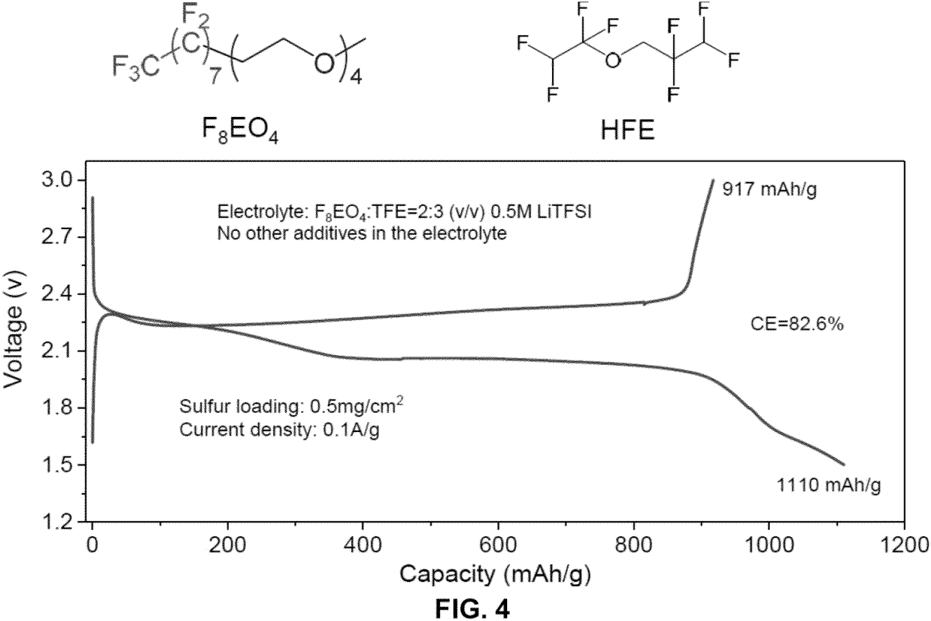

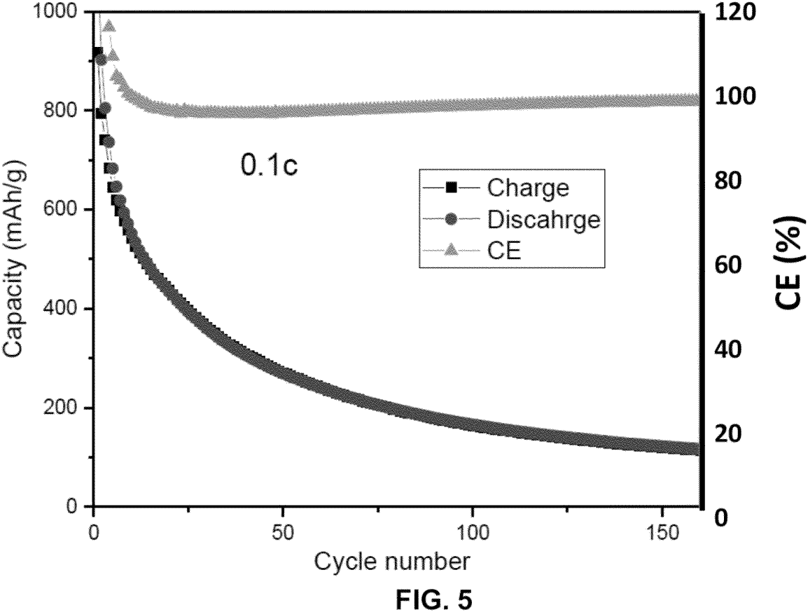

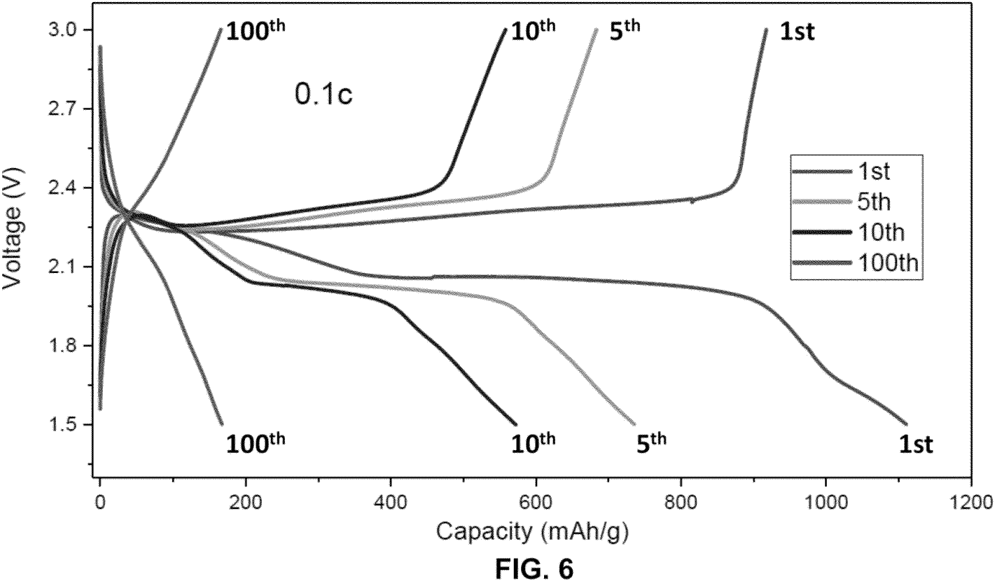

FIGS. 4-6 shows the cell test results for F₈EO₄:HFE=2:3 (v/v) 0.5 M LiTFSI.

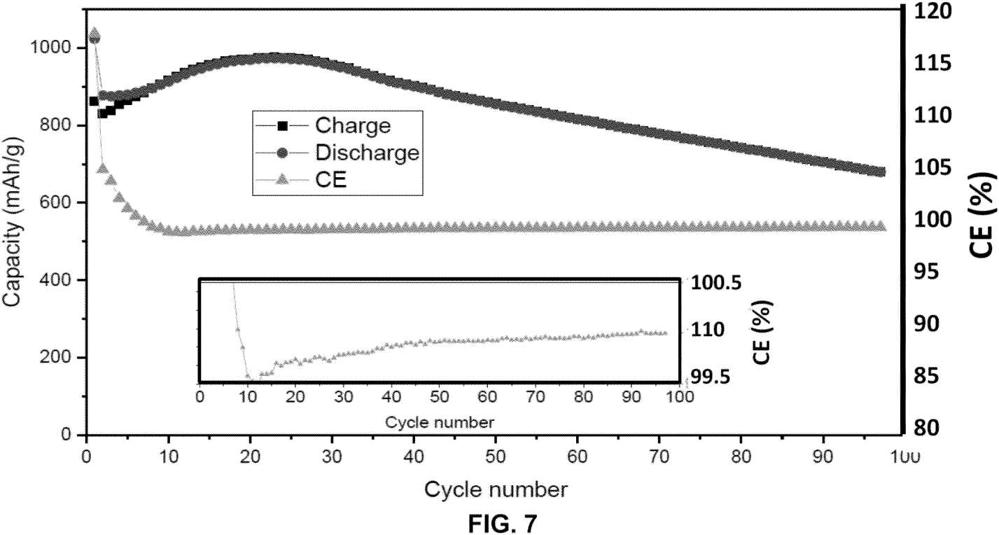

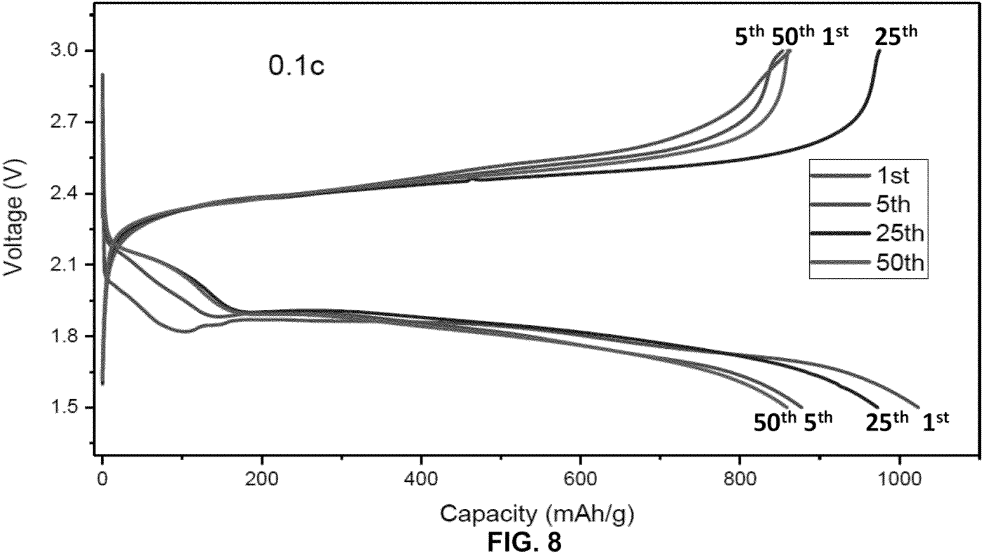

FIGS. 7 and 8 show the cell test results for F₈EO₄:HFE=1:5 (v/v) 0.5 M LiTFSI.

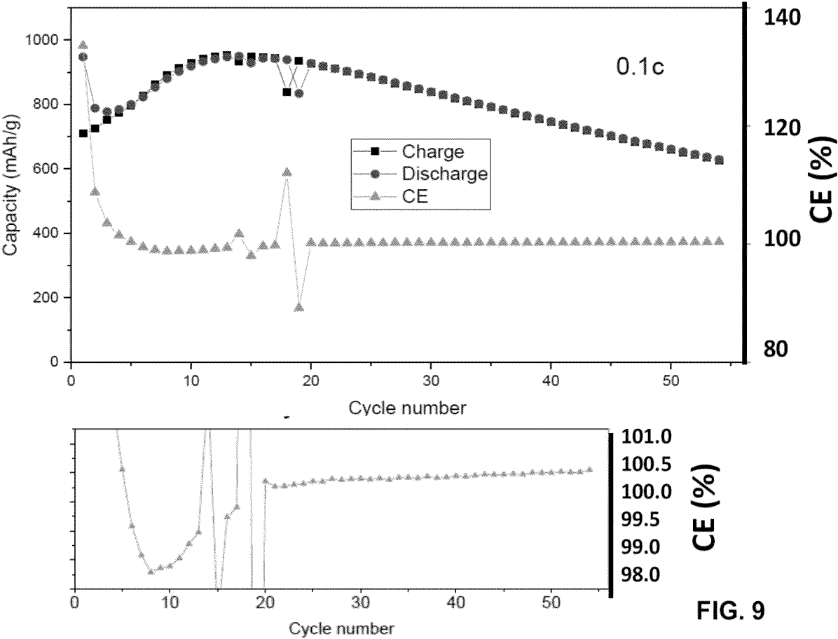

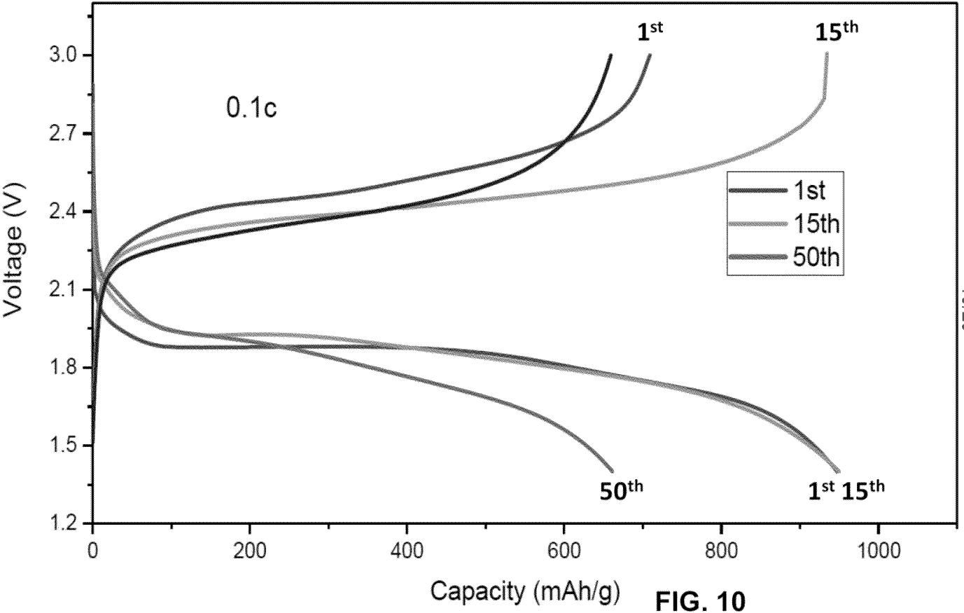

FIGS. 9 and 10 show the cell test results for F₈EO₄:HFE=9 (v/v) 0.5 M LiTFSI.

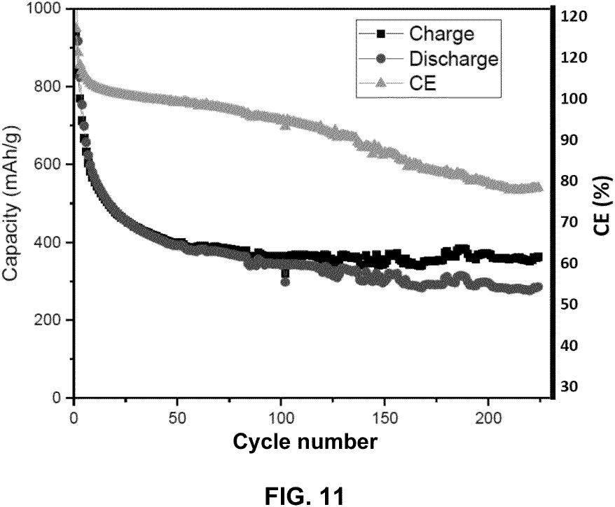

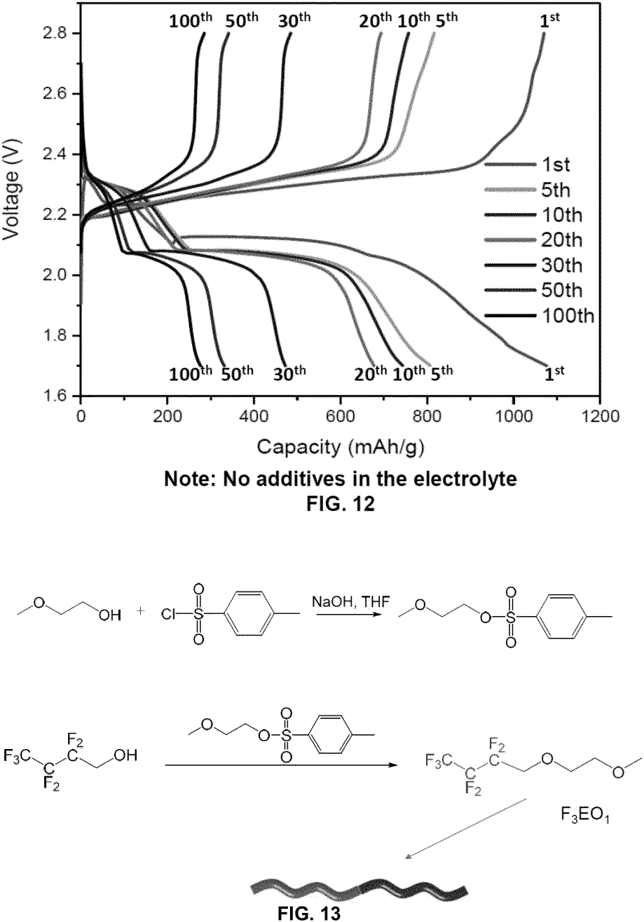

FIGS. 11 and 12 show the cell test results for DOL:DME=1: 1, 1 M LiTFSI.

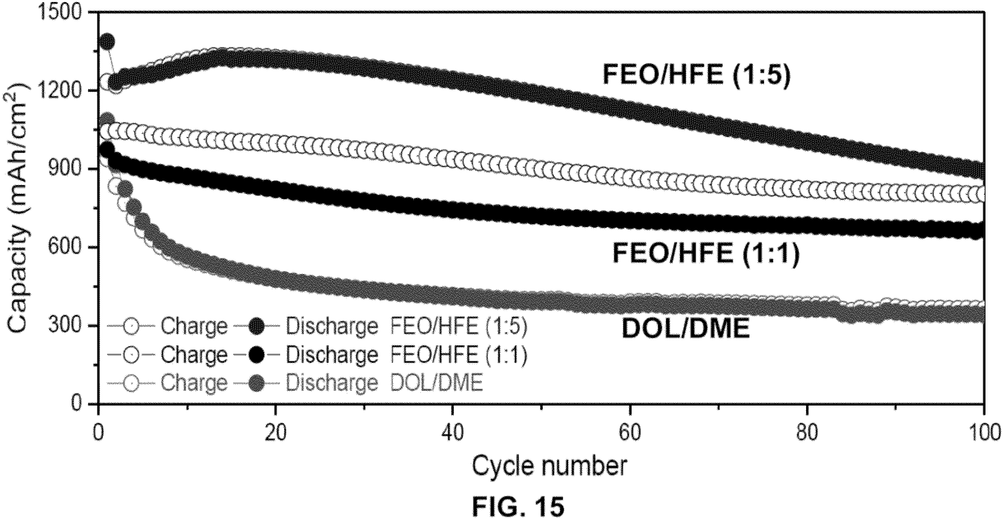

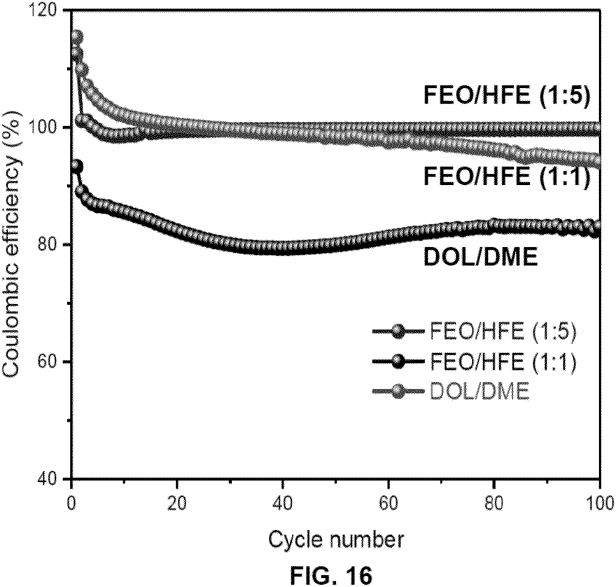

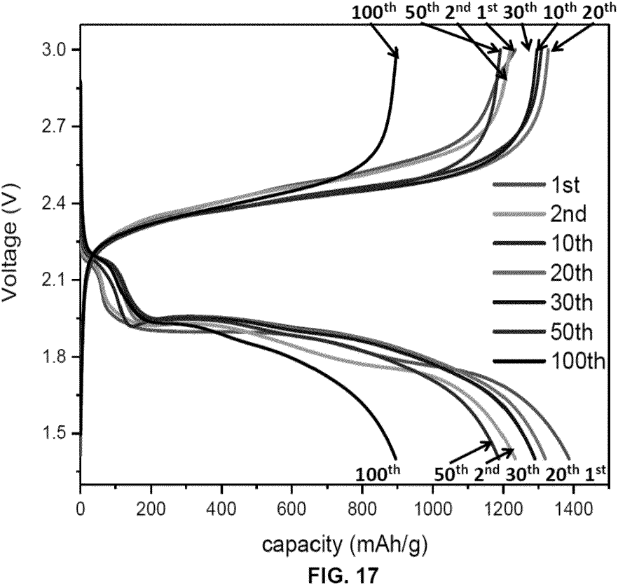

FIGS. 15-17 shows the cell test results for F₃EO₁:HFE=1:5 and 1:1 (v/v) 0.5 M LiTFSI, wherein HFE is CHF₂CF₂—O—CH₂CF₂CHF₂.

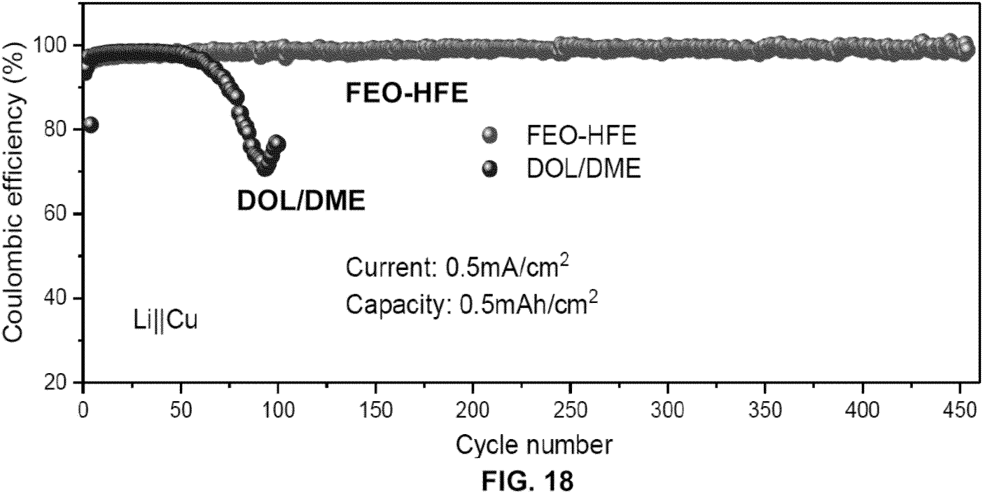

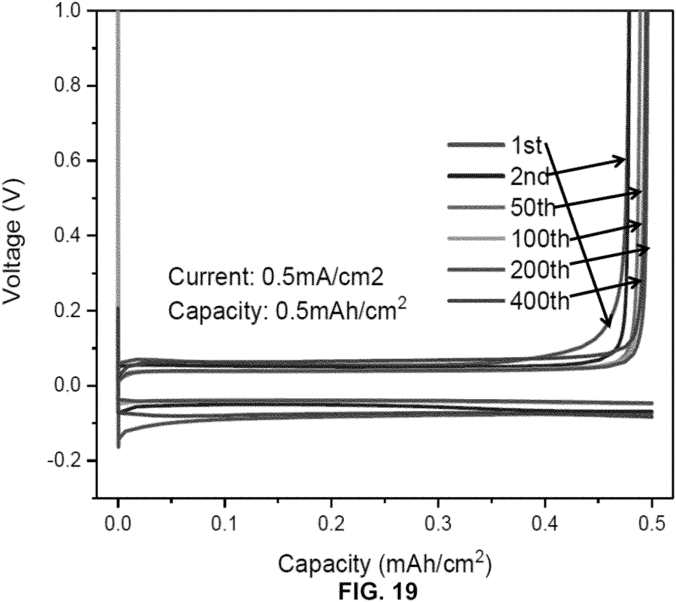

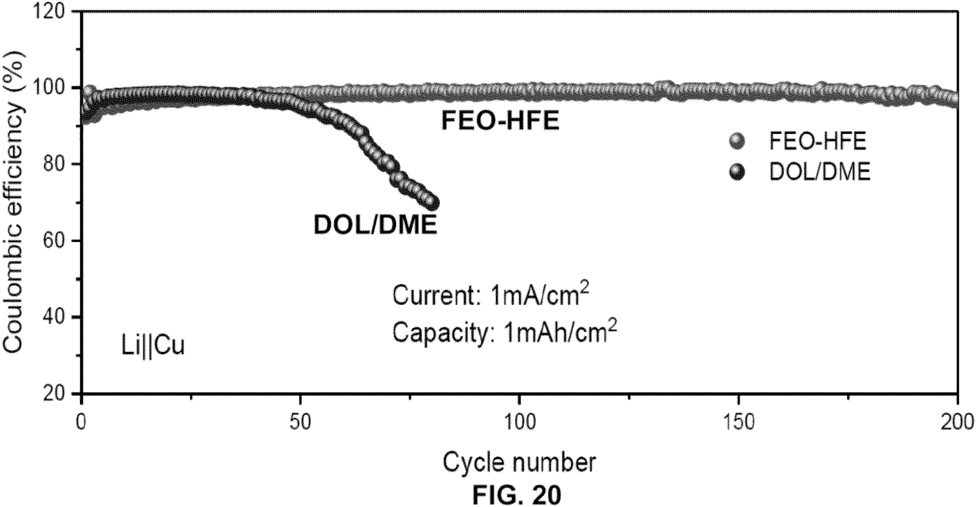

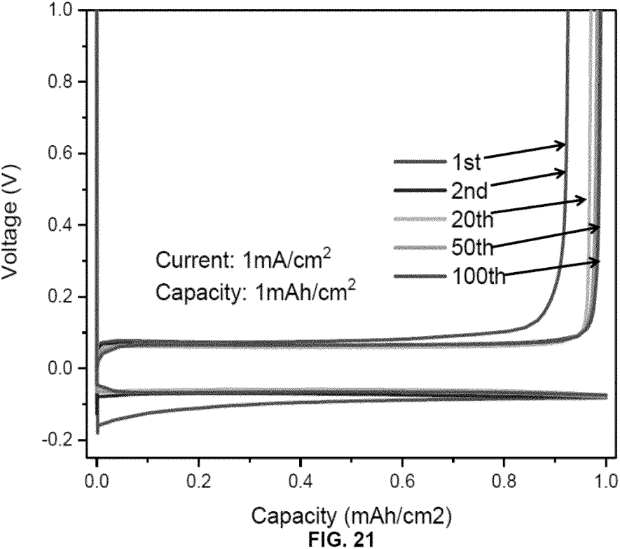

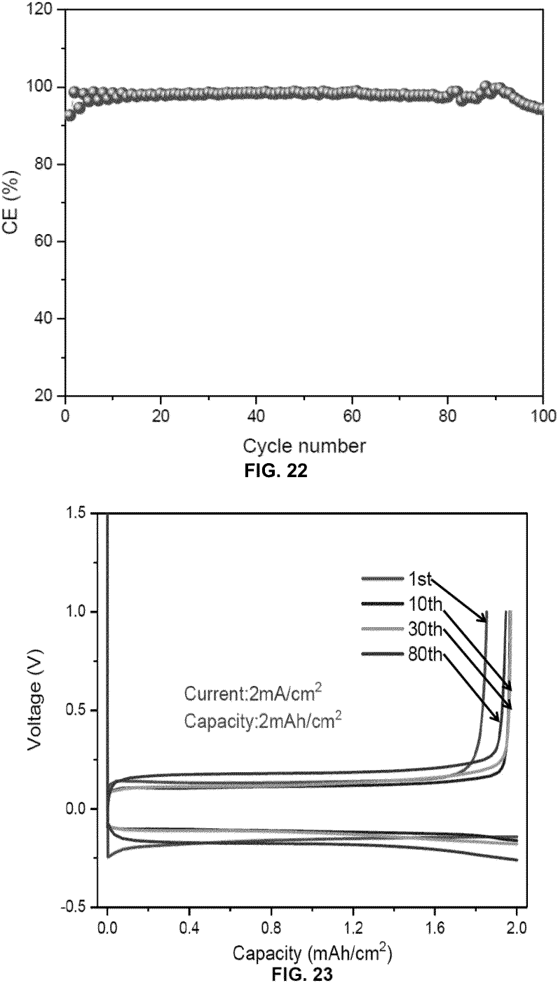

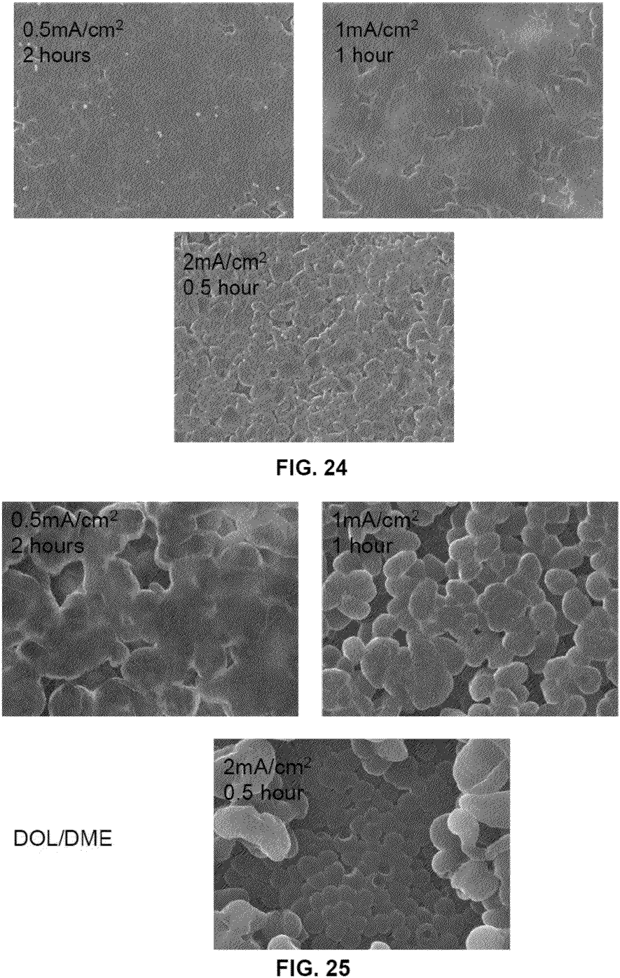

FIGS. 18-23 shows the lithium metal electrode under the F₃EO₁:HFE=1:5 (v/v) 0.5 M LiFSI electrolyte. The cell is Li metal against Cu electrode. Operated at above defined current density of 0.5 mA/cm² for 0.5, 1, or 2 hours for lithium deposition to Cu electrode, and then stripping of lithium metal from Cu electrode at the same current density unit the cell voltage reaches 1 V.

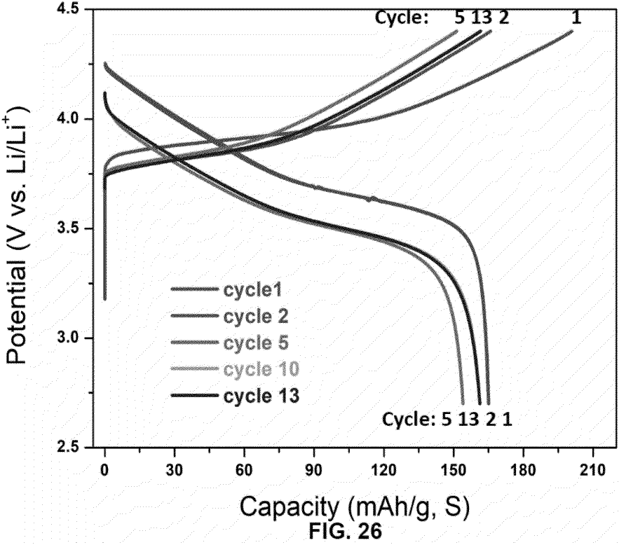

FIGS. 24 and 25 contrast the first cycle lithium metal depositions using the F₃EO₁:HFE=1:5 (v/v) 0.5 M LiFSI electrolyte and the DOL:DME=1:1 (v/v) 1 M LiTFSI electrolyte and 1% LiNO₃.

### Example 2

The project objective is to develop new electrolytes, additives, and electrode compositions for Li—S battery with high ion-conductivity, stable toward polysulfide and promoting the polysulfide affiliation with the electrode substrate to prevent polysulfide dissolution.

This work addresses the high cost and low energy density of Li-ion rechargeable batteries. The emerging Li—S batteries could feature both high energy density and low cost. This project enables applications of the low-cost, abundant sulfur element as a major chemical component for electrical energy storage. This project will develop new approaches for electrolytes and electrode compositions of LiS rechargeable batteries.

This project aims to develop new electrolytes and additives for Li—S batteries. The properties of the ideal electrolyte for sulfur electrode would be high ion conductivity, stable towards polysulfide, and promoting the polysulfide affiliation with the electrode substrate to prevent polysulfide dissolution. The project is designed to first understand the electrode substrate interaction with the polysulfides in different electrolytes. This will lead to better understanding of the polysulfide nucleation and precipitation mechanisms in common electrolytes. The second stage of the project will focus on chemically modifying the structures of the solvent and salt electrolyte molecules to increase electrolyte stability and ionic conductivity and to prevent polysulfide dissolution and promote polysulfides precipitation.

A new approach is developed using the amphiphilic hydrofluoroethers (HFE) electrolyte to further improve the sulfur (S) electrode cycling and to stabilize lithium metal. Lithium anode corrosion and dendrite formation can be significantly reduced in the electrolyte with the presence of this fluoro-based amphiphilic electrolyte and with highly concentrated salt solution, leading to high coulombic efficiency. HFE molecules are designed to have a bi-functional, amphiphilic structure consisting of a fluorocarbon moiety and an ethylene oxide (EO) moiety on each end, respectively. The molecular structure in this study is 1,1,1,2,2,3,3,4,4-nonafluoro-6-(2-methoxyethoxy)hexane (F₄EO₂). The salt is 0.5 M LiTFSI. The base solvent is 1,1,2,2-tetrafluoroethyl-2,2,3,3-tetrafluoropropyl ether (TTE) with F₄EO₂:TTE weight ratio of 1:5. The EO moiety is lithiophilic and incompatible with fluorinated solvents, therefore is able to coordinate with Li+, while the fluorocarbon moiety is lithiophobic but fluorophilic, which is associated with fluorinated TTE solvent. This structural feature results in the formation of micelle-like molecular complexes with lithium salts concentrated in the EO cores, which are dispersed by the TTE solvent. In order to improve the compatibility of the electrolyte with the S electrode, a small amount of dioxolane (DOL) is added to the micelle electrolytes. The DOL dissolves polysulfides, but at a controlled amount, the DOL acts to facilitate Li2Sx formation to significantly improve the utilization of the S materials. However, the polysulfides shuttle effects also increase at the addition of DOL. To curb the shuttle effect, additional LiTFSI is added to saturate the electrolyte to prevent the lithium polysulfides dissolution as well as to further stabilize the lithium metal electrode. By balancing the DOL amount and LiTSFI salt concentration, a Li—S cell operated above 1200 mAh/g at over 99.5% coulombic efficiency is achieved.

A strong demand for low-cost and high-energy-density rechargeable batteries has spurred lithium-sulfur (Li—S) rechargeable battery research. First, sulfur is an abundant and low-cost material. Second, the Gibbs energy of the lithium (Li) and sulfur reaction is approximately 2,600 Wh/kg, assuming the complete reaction of Li with sulfur to form Li₂S, more than five times the theoretical energy of transition metal oxide cathode materials and graphite coupling. With these advantages, Li—S batteries could be both high energy density and low cost, satisfying demand in energy storage for transportation applications. The major obstacle is the loss of sulfur cathode material as a result of polysulfide dissolution into common electrolytes, which causes a shuttle effect and significant capacity fade. The polysulfide shuttle effect leads to poor sulfur utilization and fast-capacity fade, which have hindered widespread use of rechargeable Li—S batteries. This proposed work of new electrolyte development in understanding the thermodynamics and kinetics of polysulfide dissolution and precipitation will yield new approaches for electrolytes of Li-S rechargeable batteries.

This project aims to develop new electrolytes and additives for Li—S batteries. The properties of the ideal electrolyte for sulfur electrode would be high ion conductivity, stable towards polysulfide, and promoting the polysulfide affiliation with the electrode substrate to prevent polysulfide dissolution. The first objective is to understand the electrode substrate interaction with the polysulfides in different electrolytes. This will lead to better understanding of the polysulfide nucleation and precipitation mechanisms in common electrolytes. The second objective is chemically modifying the structures of the solvent and salt electrolyte molecules to increase electrolyte stability and ionic conductivity and to prevent polysulfide dissolution and promote polysulfides precipitation.

This project aims to develop new electrolytes and additives for Li—S batteries. The properties of the ideal electrolyte for sulfur electrode would be high ion conductivity, stable towards polysulfide, and promoting the polysulfide affiliation with the electrode substrate to prevent polysulfide dissolution. The project is designed to first understand the electrode substrate interaction with the polysulfides in different electrolytes. This will lead to better understanding of the polysulfide nucleation and precipitation mechanisms in common electrolytes. The second stage of the project will focus on chemically modifying the structures of the solvent and salt electrolyte molecules to increase electrolyte stability and ionic conductivity and to prevent polysulfide dissolution and promote polysulfides precipitation.

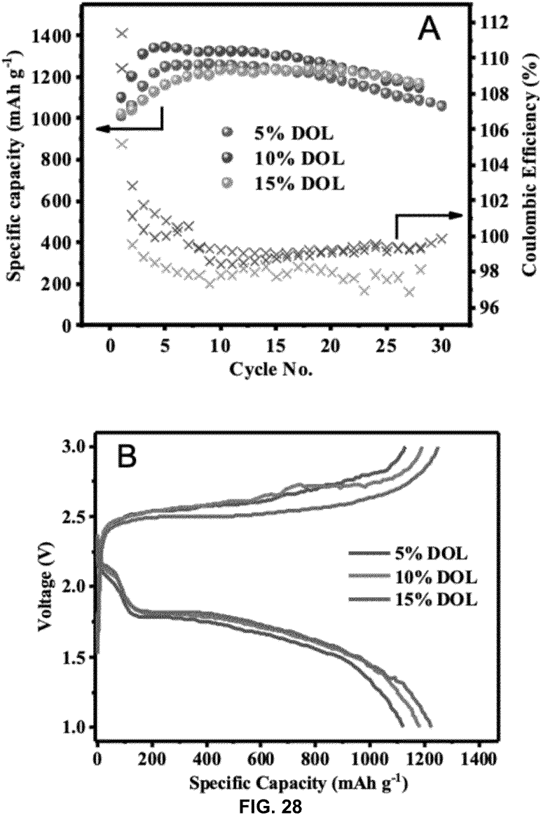

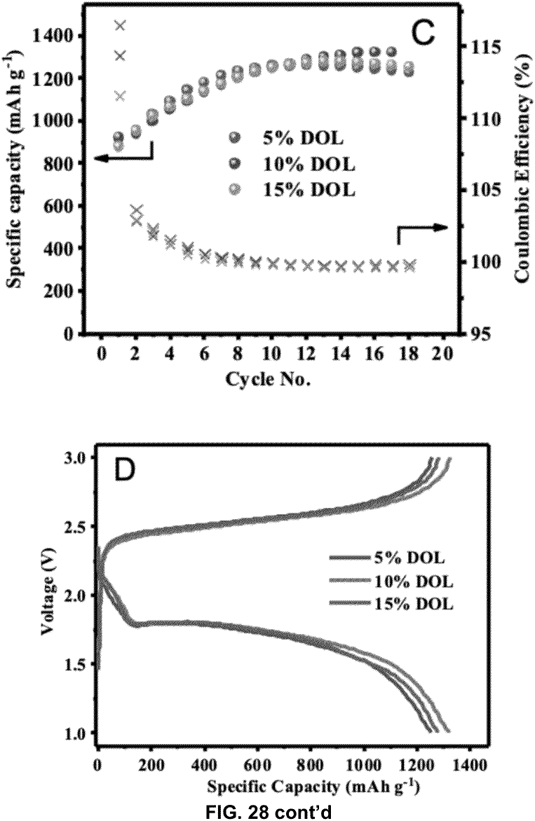

New approach is developed using the amphiphilic hydrofluoroethers (HFE) electrolyte to improve the sulfur (S) electrode cycling and to stabilize lithium metal. Lithium anode corrosion and dendrite formation can be significantly reduced in the electrolyte with the presence of this fluoro-based amphiphilic electrolyte and with highly concentrated salt solution, leading to high coulombic efficiency. Our HFE molecules are designed to have a bi-functional, amphiphilic structure consisting of a fluorocarbon moiety and an ethylene oxide (EO) moiety on each end, respectively. The molecular structure in this study is 1,1,1,2,2,3,3,4,4-nonafluoro-6-(2-methoxyethoxy)hexane (F₄EO₂). The salt is 0.5 M LiTFSI. The base solvent is 1,1,2,2-tetrafluoroethyl-2,2,3,3-tetrafluoropropyl ether (TTE) with F₄EO₂:TTE weight ratio of 1:5. The EO moiety is lithiophilic and incompatible with fluorinated solvents, therefore is able to coordinate with Li+, while the fluorocarbon moiety is lithiophobic but fluorophilic, which is associated with fluorinated TTE solvent. This structural feature results in the formation of micelle-like molecular complexes with lithium salts concentrated in the EO cores, which are dispersed by the TTE solvent. In order to improve the compatibility of the electrolyte with the S electrode, a small amount of dioxolane (DOL) is added to the micelle electrolytes. The DOL dissolves polysulfides, but at a controlled amount, the DOL acts to facilitate Li₂Sx formation to significantly improve the utilization of the S materials. However, the polysulfides shuttle effects also increase at the addition of DOL. To curb the shuttle effect, additional LiTFSI is added to saturate the electrolyte to prevent the lithium polysulfides dissolution as well as to further stabilize the lithium metal electrode. By balancing the DOL amount and LiTSFI salt concentration, a Li—S cell operated above 1200 mAh/g at over 99.5% coulombic efficiency is achieved as shown in FIG. 28.

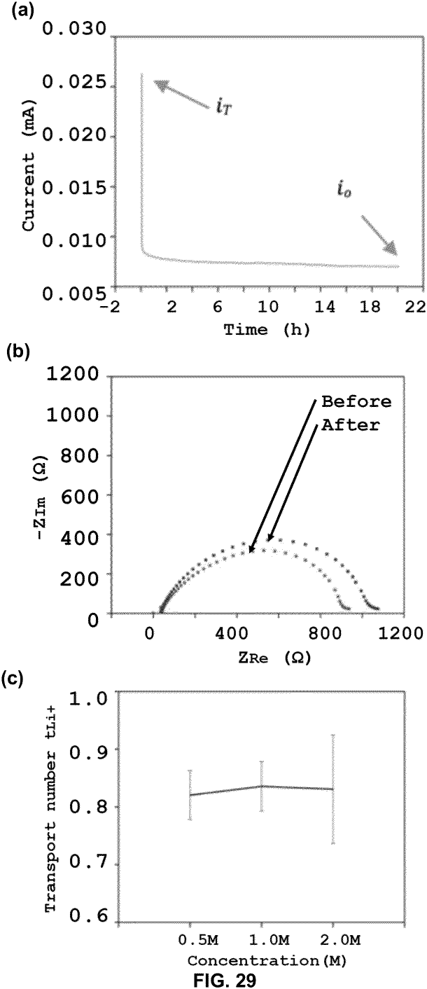

The micelle-based electrolyte was made by dissolving LiTFSI salt in F₄EO₂ fluorinated ether molecules blended with solvent TTE. This study is focused on 0.5 M and 1.0 M LiTFSI concentration electrolytes which were made by using 1:5 and 1 :2.5 F₄EO₂/TTE volume ratio respectively. A key property of the electrolyte system is transference number aside from ionic conductivity. Bruce-Vincent method is a convenient electrochemical approach to investigate electrolyte transport property which measures transference number.² The measurement was conducted on a Li—Li symmetrical cell in which the analyte electrolyte was sandwiched by two identical pieces of Li electrodes. The cell was first run two cycles of Li plating/striping at 0.4 mA/cm² for 1 h per cycle for the stable SEI formation. Next, impedance of the cell was measured with the frequency range of 300 kHz-100 mHz. The initial current i_{T}i_{T} was then measured once a small DC polarization (AFAF =10mV) was applied. After 40 hours of polarization, the steady current iₒiₒ was reached and immediately recorded. Finally, the impedance of the cell was measured again with the same frequency range. The transference number of t_{Li}+t_{Li}+ can then be expressed by the following equation:

$${t}_{L 1} + = \frac{{i}_{0} \left(Δ V - {i}_{r} {R}_{r}\right)}{{i}_{r} \left(Δ V - {i}_{o} {R}_{o}\right)}$$

where RₒRₒ and R_{T}R_{T} are the initial and steady state resistance of passive layers R_{SEI}R_{SEI} which can be extracted from the impedance measurement. FIG. 29 shows the i-t curve of polarization process and Nyquist plot of impedance measurement prior and post polarization for 0.5 M LiTFSi in F₄EO₂/TTE (v/v, 1:5) electrolyte. These two plots demonstrate the selection of important data points of iₒi_{T}iₒi_{T} and RₒRₒ, R_{T}R_{T}FIG. 28 reveals transference number as a function of LiTFSI electrolyte with 0.5 M-2.0 M concentrations. The number plotted is the average of three repeated tests with error bars included on the plot. As one can tell, the transference number of Li⁺ was ~0.8 through all concentrations which is higher than conventional liquid electrolyte systems.

Polysulfides are intermediate species formed from the lithiation and de-lithiation process of the sulfur (S) electrode. The long-chain polysulfides (Li₂Sₘ, m = 4-8) are extremely soluble in the conventional ether-based electrolyte in Li—S battery. Thus, the S electrode experiences the transformation of solid sulfur to solid Li₂S with the formation of polysulfides which have been only observed in the liquid form during cycling. By preparing electrolytes saturated with S and Li₂S at various polysulfide compositions and measuring the overall concentration of sulfur species, we are able to quantify the solubility of polysulfides in our fluorinated micelle electrolyte.

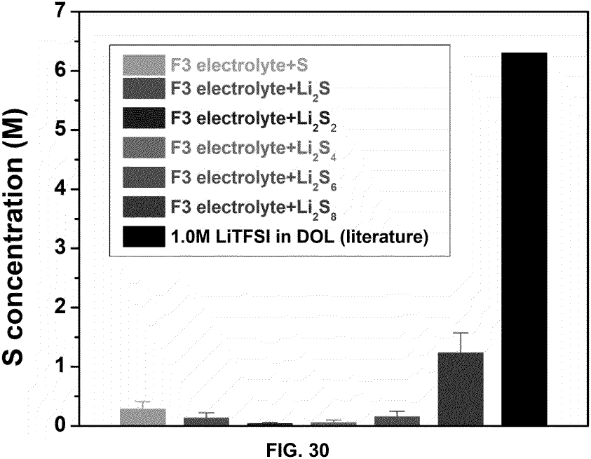

The elements C, H, N, S (weight %) were detected by the ThermoFisher Flash Smart Elemental analyzer. Various polysulfides solutions were prepared by adding and mixing Li₂S, S in 1.0 M LiTFSI F₃EO₂ /TTE electrolyte (0.3 ml, accurately measured by micropipette) based on stoichiometric ratio. The total concentration of S added is fixed at 5 M for all samples. In order to overcome the slow kinetic dissolution process, the solution was stirred at elevated temperature (60° C.) for two days and followed by continuously stirring at R.T. for another two days. The solution was syringe filtered (<0.45 µµm pore sizes) to remove the undissolved solids. The clear supernatant sample was analyzed. The weight percentage of C, H, N, S elements was measured and used to calculate the polysulfide concentration in the electrolyte. The X-axis of the molecular formula label of LiₙSₘ is nominal based on the ratio of Li and S elements in the Li₂S and S starting materials (FIG. 30). The measurement shows very limited solubility of polysulfide up to Li₂S₆ in the electrolyte. Even at Li₂S₈, the solubility of polysulfide in the F₃EO₂ /TTE electrolyte are significantly below the solubility of polysulfide in DOL based electrolyte, noted that solubility of S species is above 6 M for a typical ether solvent electrolyte. The finding indicates polysulfide dissolution was effectively suppressed in our fluorinated ether electrolyte, the result agrees with electrochemical performance.

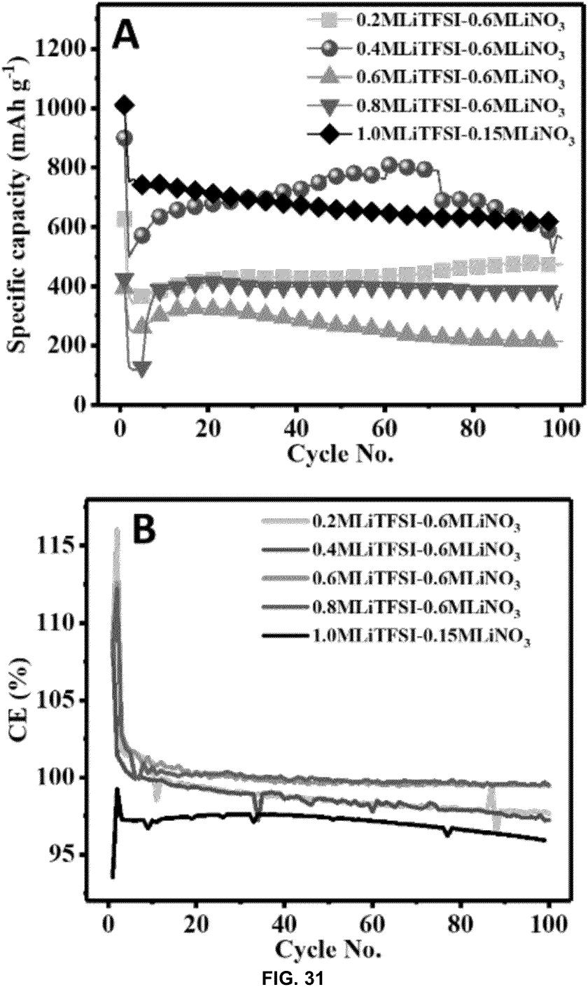

Sulfur electrode design and lithium metal anode stabilization are other important aspects to ensure proper operation of the Li—S cells. The electrolyte is one of the determining factors to the morphology and composition of sulfur electrodes. When electrolyte solvents of high polysulfide solubility are chosen such as DOE/DME, sulfur electrodes need to have high porosity and larger pore sizes to allow reversible S and Li₂S dissolution and precipitation. The larger pore sizes facilitate polysulfide transportation and precipitation during electrochemical process, especially at high current density operation. However, when an electrolyte of very low polysulfides solubilities is used, high porosity is important to accommodate volume change of the S to Li₂S transformation, but larger pore sizes are no longer critically required. Here, it is demonstrated a performance characteristic of a dissolved polysulfide solution in a traditional sulfur electrode design, when different concentrations of LiNO₃ is used to stabilize the Li metal surface. It is known that LiNO₃ additive in the electrolyte can suppress the shuttling effect and enhance cycling stability of the Li metal electrode, since it can form the good SEI layer on lithium anode and help to capture Li₂Sₓ on the cathode, decreasing of the excessive electrolyte decomposition and lithium-polysulfide migration to the anode, respectively. In addition, the LiTFSI-based electrolyte shows high conductivity and TFSI⁻ anion also can help to form a stable SEI layer on the anode. Consequently, the 1.0 M LiTFSI in DME:DOL (1/1, v/v) with 1% LiNO₃ (~0.15 M) has become the standard electrolyte for the Li—S batteries. However, the generated-SEI layer on Li anode could be unstable, and the LiNO₃ is continually consumed during the cycling process, along with the electrolyte decomposition by exposing Li metal, leading to overall decreasing of batteries performance. The alternative approach of amphiphilic hydrofluoroethers electrolyte could prevent polysulfide dissolution and stabilizing Li metal anode. In the DOE/DME (1/1, v/v) based electrolyte, the molar ratio of LiTFSI and LiNO₃ should be varied in order to obtain optimized composition in term of its high conductivity, stable SEI layer and sulfur utilization to compare the cell performance results based on amphiphilic hydrofluoroether electrolyte. Herein, the LiNO₃ concentration is fixed at 0.6 M first, and then the LiTFSI concentration varies from 0.2 - 0.8 M in the DOL/DME (1/1, v/v) system. From FIG. 31, it is observed that the Li—S cells with high LiTFSI concentration electrolytes such as 0.6 and 0.8 M LiTFSI exhibit low specific capacity. The low capacity of the cell with 0.2 M LiTFSI electrolyte could be because of its lower conductivity compared to other electrolytes. The 0.4 M LiTFSI -0.6 M LiNO₃ electrolyte having a low capacity in early cycling state shows higher capacity compared to the commercial electrolyte 1.0 M LiTFSI with 1% LiNO₃ (~0.15 M) after 30 cycles and starts to decay in capacity after 70 cycles, which might be attributed to the exhaustion of LiNO₃ portion in the electrolyte. Although the 0.6 and 0.8 M LiTFSI showed low capacity, high coulombic efficiencies are observed for these electrolytes compared to the others, as shown in FIG. 31. In a dissolved polysulfides electrolyte system (such as DOE/DME), the stabilization of Li metal electrodes is another very important factor for achieving acceptable Li-S battery electrochemical performance.

Herein is described on efforts to enable Li—S battery on two main thrusts related to the new electrolyte development. The first thrust continues our work on the novel strategy to suppress polysulfide dissolution in Li—S cells utilizing fluorinated ether with an amphiphilic additives (one lithiophilic section and one lithiophobic section) similar to that of amphiphilic surfactants. The electrolyte used in this work was made by LiTFSI dissolved in HFE solvent at various concentrations with dilution of 1,1,2,2-tetrafluoroethyl-2,2,3,3-tetrafluoropropyl ether (TTE) solvent. Lithium salts dissolution follows a special solvation mechanism where dissociated lithium ions are readily coordinated with donating groups to form micelle-like complexes, which was verified by small angle X-ray scattering. Superior cycling stability and higher coulombic efficiency was observed for Li—S cells fabricated with micelle electrolyte compared to those using benchmark DME/DOL electrolyte. Small amount of DOL was used as a co-additive to the amphiphilic electrolyte to further adjust the polysulfide dissolution and precipitation properties in the electrolyte to achieve both high sulfur utilization and electrode stability. The high coulombic efficiency indicates good chemical compatibility of amphiphilic electrolyte with sulfur electrode. In the second thrust, a high loading porous electrode architecture was tested to gauge the limit of sulfur loading. In turn, the high loading sulfur electrode also affects the lithium metal cyclability.

### RELEVANT REFERENCES

Park, H.; Tamwattana, O.; Kim, J.; Buakeaw, S.; Hongtong, R.; Kim, B.; Khomein, P.; Liu, G.; Meethong, N.; Kang, K., Probing Lithium Metals in Batteries by Advanced Characterization and Analysis Tools. Adv. Energy Mater. 2021, 11 (15), 18.

Jia, L. J.; Wang, J.; Ren, S. Y.; Ren, G. X.; Jin, X.; Kao, L. C.; Feng, X. F.; Yang, F. P.; Wang, Q.; Pan, L. D.; Li, Q. T.; Liu, Y. S.; Wu, Y.; Liu, G.; Feng, J.; Fan, S. S.; Ye, Y. F.; Guo, J. H.; Zhang, Y. G., Unraveling Shuttle Effect and Suppression Strategy in Lithium/Sulfur Cells by In Situ/Operando X-ray Absorption Spectroscopic Characterization. Energy Environ. Mater. 2021, 4 (2), 222-228.

He, X.; Liu, Z. M.; Gao, G. P.; Liu, X. T.; Swietoslawski, M.; Feng, J.; Liu, G.; Wang, L. W.; Kostecki, R., Revealing the working mechanism of a multi-functional block copolymer binder for lithium-sulfur batteries. J. Energy Chem. 2021, 59, 1-8.

Y. Zhao, C. Fang, G. Zhang, D. Hubble, A. Nallapaneni, C. Zhu, Z. Zhao, Z. Liu, J. Lau, Y. Fu, G. Liu, “A Micelle Electrolyte Enabled by Fluorinated Ether Additives for Polysulfide Suppression and Li Metal Stabilization in Li-S Battery”, Front. Chem. 2020, 8, 484.

H. Zhong, Y. Zhao, T. Zhang, G. Liu, “Controlled Lithium Deposition on Alq₃ Coated Substrate”, Batteries & Supercaps, 2020, 3, 1-9.

Li, Z. H.; Fang, C.; Qian, C.; Zhou, S. D.; Song, X. Y.; Ling, M.; Liang, C. D.; Liu, G., Polyisoprene Captured Sulfur Nanocomposite Materials for High-Areal-Capacity Lithium Sulfur Battery. ACS Appl. Polym. Mater. 2019, 1 (8), 1965-1970.

Fang, C.; Zhang, G. Z.; Lau, J.; Liu, G., Recent advances in polysulfide mediation of lithium-sulfur batteries via facile cathode and electrolyte modification. APL Mater. 2019, 7 (8), 7.

Yang, C. A.; Du, Q. K.; Li, Z. H.; Ling, M.; Song, X. Y.; Battaglia, V.; Chen, X. B.; Liu, G., In-situ covalent bonding of polysulfides with electrode binders in operando for lithium-sulfur batteries. Journal of Power Sources 2018, 402, 1-6.

Borchert, H.; Shevchenko, E. V.; Robert, A.; Mekis, I.; Kornowski, A.; Grübel, G.; Weller, H., Determination of Nanocrystal Size: A Comparison of TEM, SAXS, and XRD Studies of Highly Monodisperse CoPt3 Particles. Langmuir 2005, 21, 1931-1936

Yin, Y. X.; Xin, S.; Guo, Y. G.; Wan, L. J., Lithium-sulfur batteries: electrochemistry, materials, and prospects. Angew. Chem., Int. Ed. Engl. 2013, 52 (50), 13186-13200.

Zhang, X.-Q.; Cheng, X.-B.; Chen, X.; Yan, C.; Zhang, Q., Fluoroethylene Carbonate Additives to Render Uniform Li Deposits in Lithium Metal Batteries. Advanced Functional Materials 2017, 27 (10).

Y. Guo, H. Li, T. Zhai, Reviving Lithium-Metal Anodes for Next-Generation High-energy Batteries, Adv Mater. 2017, 29.

H. Ye, Z. J. Zheng, H. R. Yao, S. C. Liu, T. T. Zuo, X. W. Wu, Y. X. Yin, N. W. Li, J. J. Gu, F. F. Cao, Y. G. Guo, Guiding Uniform Li Plating/Stripping through Lithium-Aluminum Alloying Medium for Long-Life Li Metal Batteries, Angew Chem Int Ed Engl. 2019, 58, 1094-1099.

Y. Hamon, T. Brousse, F. Jousse, P. Topart, P. Buvat, D. M. Schleich, Aluminum negative electrode in lithium ion batteries, J. Power Sources. 2001, 97, 185-187.

H. Wu, Y. Cao, L. Geng, C. Wang, In Situ Formation of Stable Interfacial Coating for High Performance Lithium Metal Anodes, Chem. Mater. 2017, 29, 3572-3579.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

All cited references are hereby each specifically incorporated by reference in their entirety.

What is claimed is:

1. An electrolyte composition comprising an ether solvent, an amphiphilic molecule, an electrolyte solvent, and a lithium salt.

2. The electrolyte composition of claim 1, wherein the ether solvent comprises an ether solvent molecule comprising an ether functional group, a carbonate functional group, or an ester functional group, or any mixture thereof.

3. The electrolyte composition of claim 1, wherein the ether solvent molecule is linear or cyclic.

4. The electrolyte composition of claim 1, wherein the ether solvent molecule comprises a plurality of ether functional groups, carbonate functional groups, or ester functional groups, or any mixture thereof.

5. The electrolyte composition of claim 1, wherein the ether solvent molecule is a polymer.

6. The electrolyte composition of claim 1, wherein the ether solvent molecule is any one of the following molecules: dimethyl ether (CH³—O—CH³), ethyl methyl ether (CH³CH²—O—CH³), diethyl ether (CH³CH²—O—CH²CH³), dipropyl ether (CH³CH²CH²—O—CH²CH²CH³), diisopropyl ether ((CH³)²CH—O—CH(CH³)²), divinyl ether (CH²═CH—O—CH═CH²), 1,2-dimethoxyethane (DME) (CH³OCH²CH²OCH³), methyl phenyl ether (anisole) 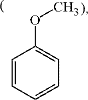
cyclopropyl methyl ether ( 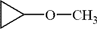
), diphenyl ether ( 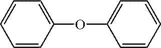 [SMILES: c1ccc(Oc2ccccc2)cc1]
), furan ( 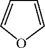
), tetrahydrofuran (THF) ( 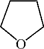
), 1,4-dioxane ( 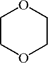
), or a mixture thereof.

7. The electrolyte composition of claim 1, wherein the ether solvent molecule is a cyclic ether having any one of the following structures: 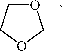 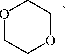 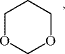 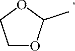 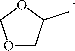 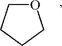 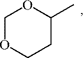 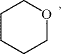 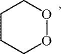
or a mixture thereof.

8. The electrolyte composition of claim 1, wherein the ether solvent molecule is a cyclic carbonate having any one of the following structures: 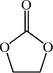 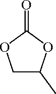 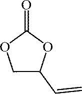 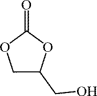 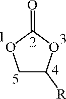 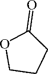 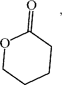
or a mixture thereof.

9. The electrolyte composition of claim 1, wherein the ether solvent molecule is a cyclic ester having any one of the following structures: 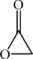 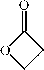 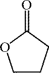 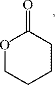
or a mixture thereof.

10. The electrolyte composition of claim 7, wherein ether solvent molecule is dioxolane (DOL).

11. The electrolyte composition of claim 1, wherein the amphiphilic molecule has the following structure: 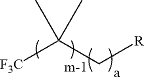
; wherein R is 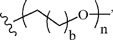 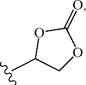 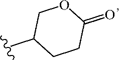 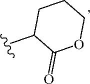 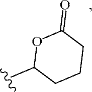 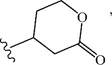 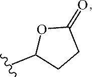 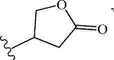 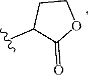 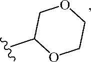 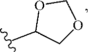 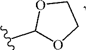 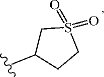 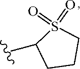 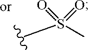
m is an integer from 1 to 21; a is an integer from 0 to 20; b is an integer from 0 to 4; and n is an integer from 1 to 20.

12. The electrolyte composition of claim 11, wherein m is 1, 2, 3, 4, 5, 6, 7, 8, 9, 10, 11, 12, 13, 14, 15, 16, 17, 18, 19, or 20.

13. The electrolyte composition of claim 11, wherein a is 1, 2, 3, 4, 5, 6, 7, 8, 9, 10, 11, 12, 13, 14, 15, 16, 17, 18, or 19.

14. The electrolyte composition of claim 11, wherein b is 0, 1, 2, or 3.

15. The electrolyte composition of claim 11, wherein n is 1, 2, 3, 4, 5, 6, 7, 8, 9, 10, 11, 12, 13, 14, 15, 16, 17, 18, or 19.

16. The electrolyte composition of claim 11, wherein the amphiphilic molecule has the following structure: 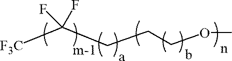
; wherein m is an integer from 1 to 21, a is an integer from 0 to 20, b is an integer from 0 to 4, and n is an integer from 1 to 20.

17. The electrolyte composition of claim 11, wherein R is 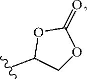 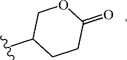 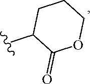 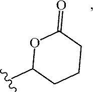 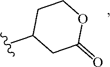 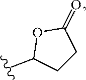 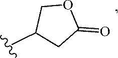 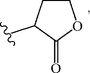 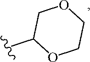 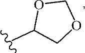 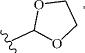 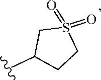 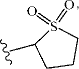
or 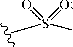
wherein m is an integer from 1 to 21; a is an integer from 0 to 20.

18. The electrolyte composition of claim 17, wherein the amphiphilic molecule has the following structure: 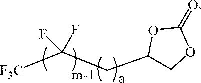 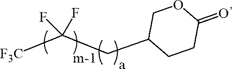 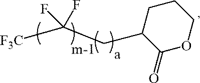 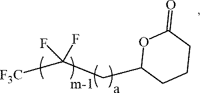 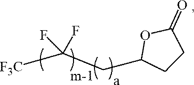 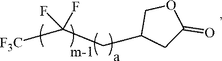 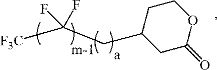 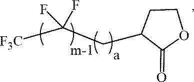 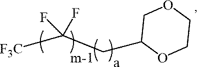 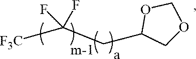 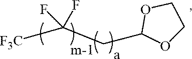 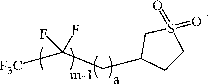 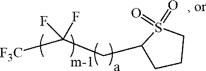 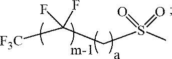
wherein m is an integer from 1 to 21; a is an integer from 0 to 20.

19. The electrolyte composition of claim 1, wherein the amphiphilic molecule is capable of self-formation of a micelle.

20. The electrolyte composition of claim 1, wherein the electrolyte solvent has the following chemical structure: R₁—O—R₂, or 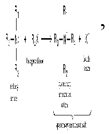 wherein R₁ is —CH₃, —C₂H₅, or —R₄; and R₂, R₃, and R₄ are each independently -a-C_{y}H_{z}F_{2y}+_{i-z}, wherein a is -, —CHF—, —CF₂—, or —CH₂—; y is 1, 2, 3, 4, 5, 6, 7, 8, 9, or 10; and z is 0 or 1.

21. The electrolyte composition of claim 20, wherein the -C_{y}F_{y+2} is a straight chain alkyl.

22. The electrolyte composition of claim 20, wherein the -C_{y}F_{2y}+ᵢ is a branched alkyl, and y is equal to or more than 3.

23. The electrolyte composition of claim 20, wherein R₁ and R₂ are identical.

24. The electrolyte composition of claim 20, wherein R₂ and R₃ are identical.

25. The electrolyte composition of claim 20, wherein R₁, R₂, and R₃ are identical.

26. The electrolyte composition of claim 20, wherein the electrolyte solvent is methoxyperfluorobutane, perfluorinated alkane, bis(2,2,2-trifluoroethyl)ether, 1,1,2,2-tetrafluoroethyl-2′,2′,2′-trifluoroethyl ether, perfluorotributylamine, hydrofluoroether (HFE), or a mixture thereof.

27. The electrolyte composition of claim 26, wherein the perfluorinated alkane is CF₃(CF₂)_{X}CF₃, wherein x is an integer from 0 to 20.

28. The electrolyte composition of claim 27, wherein x is 1, 2, 3, 4, 5, 6, 7, 8, 9, 10, 11, 12, 13, 14, 15, 16, 17, 18, 19, or 20.

29. The electrolyte composition of claim 26, wherein the hydrofluoroether (HFE) is CHF₂CF₂-O-CH₂CF₂CHF₂, C₇F₁₅—O—C₂H₅, C₄F₉—O—C₂H₅, n-C₃F₇-O-CH₃), CF₃CF₂-O-CH₃, CF₃CHFCF₂—O—CH₃, CF₃—O—CH₃, CHF₂—O—CHF₂, CF₃CF₂—O—CH₃), or CF₃—O—CHFCF₃.

30. The electrolyte composition of claim 29, wherein the HFE is CHF₂CF₂—O—CH₂CF₂CHF₂.

31. The electrolyte composition of claim 1, wherein the lithium salt is lithium bis(trifluoromethanesulfonyl)imide (LiTFSI), lithium bis(oxalato)borate (LiBOB), lithium bis(pentafluoroethanesulfonyl)imide (LiBETI), LiClO₄, lithium bis(fluorosulfonyl)imide (LiFSI), LiPF₆, LiAsF₆, or a mixture thereof.

32. The electrolyte composition of claim 31, wherein the lithium salt has an ionic association strength that is equal to or less than about the ionic association strength of LiBETI, and is equal to or more than about the ionic association strength of LiTFSI.

33. A lithium ion battery comprising the electrolyte composition of claim 1.
